(19) United States
(12) Patent Application Publication
(10) Pub. No.: US 2015/0207380 A1
(43) Pub. Date: Jul. 23, 2015

(54) ELECTRIC MOTOR SUPPORT STRUCTURE AND COMPRESSOR

(71) Applicants: IHI Corporation, Tokyo (JP); IHI COMPRESSOR AND MACHINERY CO., LTD, Toko (JP)

(72) Inventors: Toshimichi Taketomi, Tokyo (JP); Masafumi Hara, Tokyo (JP)

(21) Appl. No.: 14/417,190

(22) PCT Filed: Aug. 26, 2013
(86) PCT No.: PCT/JP2013/072685

§ 371 Date: Jan. 26, 2015

(30) Foreign Application Priority Data
Aug. 27, 2012 (JP) 2012-186438

(51) Int. Cl. H02K 5/26; F16M 1/04

(52) U.S. Cl. CPC H02K 5/26; F16M 1/04

(57) ABSTRACT

An electric motor support structure (A) includes: a base (20) that has a cantilever support unit (21) and a mount unit (22), the cantilever support unit (21) supporting an electric motor main unit (11) with a first end part (13A) thereof in an axial direction being fixed and a second end part (13B) thereof being free, and the mount unit (22) having a support surface (24) that supports the second end part (13B) of the electric motor main unit (11); and a support member (30) that restricts relative movement between the electric motor main unit (11) and the mount unit (22) in an orthogonal direction parallel to the support surface (24) and also orthogonal to the axial direction and makes possible a relative movement between the electric motor main unit (11) and the mount unit (22) in a direction vertical to the support surface (24). With this electric motor support structure (A), it is possible to suppress vibration of the electric motor without applying an undue force to the cantilever support unit (21).

### TECHNICAL FIELD

The present invention relates to an electric motor support structure and a compressor.

Priority is claimed on Japanese Patent Application No. 2012-186438, filed on Aug. 27, 2012, the contents of which are incorporated herein by reference.

### BACKGROUND ART

Patent Document 1 below discloses a dry screw compressor including an electric motor in which a bull gear is attached to a shaft end, and the bull gear is used to revolve a rotor provided with a pinion, to thereby drive a first-stage compressor and a second-stage compressor. In this compressor, an electric motor main unit is supported in a cantilever manner with respect to a step-up gear casing that contains the bull gear (for example, see FIG. 15 of Patent Document 1).

Although not explicitly shown in Patent Document 1, the free end side of the electric motor, which is supported in a cantilever manner, is supported by a mount from beneath so that only the self-weight of the electric motor is received by the mount. Namely, when operating the compressor, the casing side is heated to a higher temperature by the compression action of fluid. Therefore, greater difference in thermal expansion arises between the cantilever supporting section, which supports the electric motor main unit in a cantilever manner near this heat source, and the mount section, which supports the electric motor main unit away from the heat source. In this condition, if the movement of the free end side of the electric motor main unit is restricted in the vertical direction, an undue force may be applied to the cantilever supporting section. Accordingly, in the case of Patent Document 1, a support structure is used at the free end side of the electric motor to receive only the self-weight of the electric motor.

### CITATION LIST

### Patent Documents

Patent Document 1: Japanese Patent No. 4003378

### SUMMARY OF INVENTION

### Technical Problem

In an electric motor, vibration caused by the electric motor is larger in the case of an increased imbalance of the electric motor due to aged deterioration or other cases. In this case, when using a conventional support structure that receives only the self-weight of the electric motor, there may be a problem in that the vibration in the left-right direction (horizontal direction) is larger.

The present invention has been achieved in view of the above problem, and has an object to provide an electric motor support structure and a compressor that are capable of suppressing vibration without applying an undue force to a cantilever supporting section.

### Solution to Problem

To solve the above problem, a first aspect according to the present invention is an electric motor support structure that includes: a base that has a cantilever support unit and a mount unit, the cantilever support unit supporting an electric motor main unit with a first end part of the electric motor main unit in an axial direction being fixed and a second end part of the electric motor main unit being free, and the mount unit having a support surface that supports the second end part of the electric motor main unit; and a relative movement control member that restricts a relative movement between the electric motor main unit and the mount unit in an orthogonal direction parallel to the support surface and orthogonal to the axial direction, and that makes possible relative movement between the electric motor main unit and the mount unit in a direction vertical to the support surface.

In the present invention, there is provided a relative movement control member that restrains the free end side of the electric motor main unit in the orthogonal direction and does not restrain the free end side in the vertical direction. The orthogonal direction is a direction that is parallel to the support surface of the mount unit and that is orthogonal to the axial direction of the electric motor main unit. Therefore, it is possible to effectively suppress vibration from shaft deflection caused by an imbalance of the electric motor. Furthermore, the vertical direction is a direction that is vertical to the support surface of the mount unit. Therefore, a vertical relative movement of the electric motor main unit is made possible, which prevents an undue force caused by thermal expansion from being applied to the electric motor.

In a second aspect according to the present invention, the relative movement control member is a plate-like member that is connected to the second end part of the electric motor main unit and to the base, and that extends in the orthogonal direction.

With a plate-like member being installed so as to extend in the orthogonal direction that is orthogonal to the axial direction, it is possible to establish, at low a cost, a structure that increases rigidity in the orthogonal direction and is not allowed to have rigidity in the vertical direction high enough to prohibit a thermal expansion of the electric motor main unit. Furthermore, this rigidity makes it possible to restrain the relative movement in the orthogonal direction and makes the relative movement in the vertical direction possible.

In a third aspect according to the present invention, the plate-like member has a spring characteristic of being freely deformable in the vertical direction.

With this construction being adopted, in the present invention, the plate-like member is freely deformed by following the relative movement of the electric motor main unit. This makes the relative movement in the vertical direction possible.

In a fourth aspect according to the present invention, the plate-like member has a bent section between the second end part of the electric motor main unit and the base. With the bent section, which facilitates deformation of the plate-like member, being provided partway between the second end part of the electric motor main unit and the base, it is possible not to allow the plate-like member to have rigidity in the vertical direction.

In a fifth aspect according to the present invention, the plate-like member has an extension section that extends linearly between the second end part of the electric motor main unit and the base. Further, at least one of a first fixation section, which fixes the plate-like member to the second end part of the electric motor main unit, and a second fixation section, which fixes the plate-like member to the base, does not have a support on an extended line of the extension section.

In the present invention, the extension section is not restricted in the vertical direction by the first fixation section and the second fixation section. Therefore, it is possible not to allow the plate-like member to have rigidity in the vertical direction high enough to prohibit thermal expansion of the electric motor main unit.

A compressor having an electric motor according to the present invention includes the aforementioned electric motor support structure as a support structure that supports the electric motor.

With this construction being adopted, it is possible to obtain a compressor capable of effectively suppressing vibration caused by an imbalance of the electric motor, and capable of preventing an undue force caused by thermal expansion from being applied to the electric motor.

### Advantageous Effects of Invention

According to the present invention, it is possible to obtain an electric motor support structure and a compressor that are capable of suppressing vibration without applying an undue force to a cantilever supporting section.

### BRIEF DESCRIPTION OF DRAWINGS

FIG. 1A is a front view showing a compressor including an electric motor support structure according to an embodiment of the present invention.

FIG. 1B is a right side view showing the compressor including the electric motor support structure according to the embodiment of the present invention

FIG. 2 is an enlarged view of the main part in FIG. 1A.

FIG. 3A is an enlarged view of the main part of a support member according to another embodiment of the present invention, which shows a construction thereof

FIG. 3B is an enlarged view of the main part of a support member according to another embodiment of the present invention, which shows a construction thereof.

FIG. 3C is an enlarged view of the main part of a support member according to another embodiment of the present invention, which shows a construction thereof.

FIG. 3D is an enlarged view of the main part of a support member according to another embodiment of the present invention, which shows a construction thereof.

FIG. 4A is a right side view showing a compressor including an electric motor support structure according to another embodiment of the present invention.

FIG. 4B is a right side view showing a compressor including an electric motor support structure according to another embodiment of the present invention.

### DESCRIPTION OF EMBODIMENTS

Hereunder is a description of an embodiment of the present invention with reference to the drawings. In the following description, illustration is for the case where an electric motor support structure of the present invention is applied to a compressor. Furthermore, in the following description, there are cases where, with an XYZ orthogonal coordinate system being established, positional relationships among respective members are explained with reference to the XYZ orthogonal coordinate system. A predetermined direction within a horizontal plane is made an X axis direction, a direction orthogonal to the X axis direction within the horizontal plane is made a Y axis direction, and a direction orthogonal to both of the X axis direction and the Y axis direction (namely, a vertical direction) is made a Z axis direction.

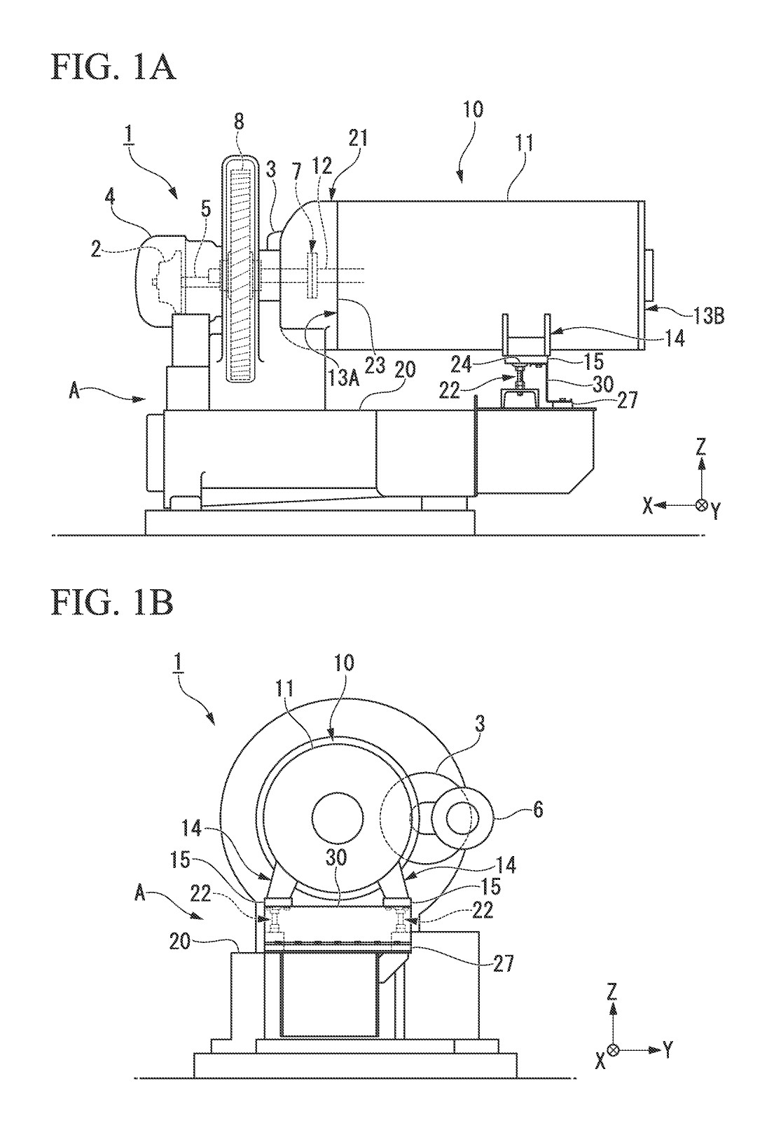

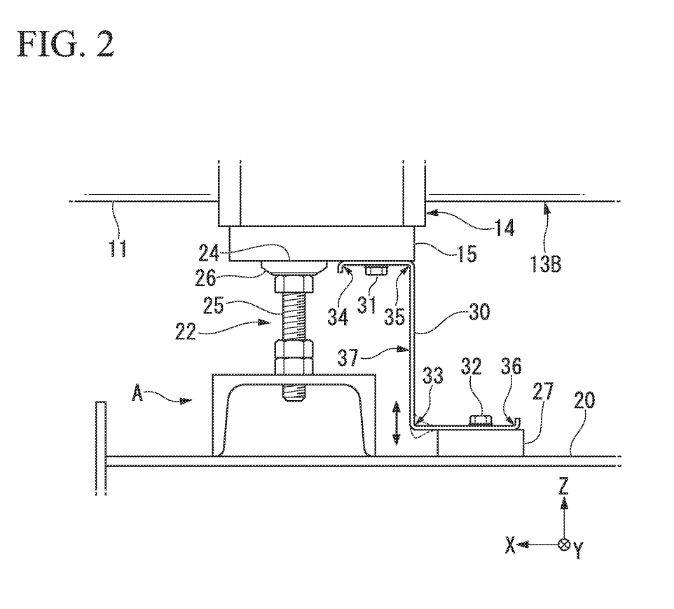

FIG. 1A is a front view showing a compressor 1 including a support structure A for an electric motor 10 according to an embodiment of the present invention. FIG. 1B is a right side view of the compressor 1 shown in FIG. 1A. FIG. 2 is an enlarged view of the main part in FIG. 1A.

As shown in FIG. 1A, the compressor 1 is a turbo compressor that compresses a fluid such as air by revolving a compressor impeller 2.

The compressor 1 is a two-stage compressor including: a first-stage compressor 3 (see FIG. 1B) that compresses a fluid; and a second-stage compressor 4 (see FIG. 1A) that further compresses the fluid having been subjected to the first-stage compression. The compressor 1 has: an electric motor 10 that drives the first-stage compressor 3 and the second-stage compressor 4; and a support structure A that supports the electric motor 10. Each of the first-stage compressor 3 and the second-stage compressor 4 contains a compressor impeller 2. The compressor impellers 2 are connected by a rotor 5.

The compressor impeller 2 is a radial impeller, and has blades (not shown in the figure) including a three-dimensional twist that guides an axially-inhaled gas outwardly in a radial direction. Around each of the compressor impellers 2, there is provided a diffuser flow passage (not shown in the figure). Therefore, it is possible to compress and pressurize a radially-guided gas in this flow passage, and also to supply the gas to a compressor in the subsequent stage via a scroll flow passage provided therearound.

As shown in FIG. 1B, the first-stage compressor 3 includes an induction pipe 6. The induction pipe 6 is arranged on a side of an electric motor main unit 11 so as to be parallel with the electric motor main unit 11. A gas having passed through the induction pipe 6 is input to the first-stage compressor 3. After the gas undergoes the first-stage compression in the first-stage compressor 3, the compressed gas is cooled by passing through an intercooler (not shown in the figure), and is then input to the second-stage compressor 4. After the gas undergoes the second-stage compression in the second-stage compressor 4, the compressed gas passes through an aftercooler (not shown in the figure), and is then supplied to an industrial machine (not shown in the figure) or the like that is connected to the compressor 1.

As shown in FIG. 1A, the electric motor 10 has the cylindrical electric motor main unit 11 that contains stators (not shown in the figure) for revolving a rotor 12 about an axis extending in the horizontal direction (X axis direction). The rotor 12 is connected to a bull gear 8 via a shaft coupling 7. The bull gear 8 is in engagement with a pinion (not shown in the figure) provided on the rotor 5 of the compressor impellers 2. Therefore, with the revolution of the bull gear 8, the first-stage compressor 3 and the second-stage compressor 4 are synchronously driven.

As shown in FIG. 1A, the support structure A has a base 20 which contains a gear device including the bull gear 8, and the like. The base 20 is an L-shaped casing. An oil tank (not shown in the figure) for supplying oil to a revolution section and a sliding section, the aforementioned intercooler, and other pipes, measurement devices, and the like (not shown in the figure) are provided in the base 20. The base 20 has: a cantilever support unit 21 that supports the electric motor main unit 11 in a cantilever manner; and mount units 22 that support a lower portion of the electric motor main unit 11.

The cantilever support unit 21 supports the electric motor main unit 11 with a first end part 13A thereof in the axial direction (X axis direction) being fixed and with a second end part 13B thereof being free. The cantilever support unit 21 is integral with the base 20, and is formed in a bowl shape whose diameter is the same as that of the first end part 13A of the electric motor main unit 11. To a flange section 23 at an opening edge of the cantilever support unit 21, the first end part 13A of the electric motor main unit 11 is connected. Note that the flange section 23 and the electric motor main unit 11 are connected to each other with a plurality of rods (not shown in the figure) that extend in the X axis direction. The cantilever support unit 21 supports the electric motor main unit 11 in a horizontal posture.

The mount units 22 support the second end part 13B, which is the free end of the electric motor main unit 11, and receive only the self-weight of the electric motor main unit 11. The mount unit 22 has a support surface 24. One of leg units 14 that are provided on the second end part 13B of the electric motor main unit 11 is mounted on the support surface 24. As shown in FIG. 1B, leg units 14 are provided pairwise on side bottom portions of the electric motor main unit 11. Therefore, the mount unit 22 of the present embodiment is provided on the base 20 at two sites corresponding with the leg units 14.

As shown in FIG. 2, the mount unit 22 has: a threaded shaft 25 erectly provided in the vertical direction (Z axis direction); and a pad 26 provided at a front end of the threaded shaft 25. The pad 26 is circular when seen in a planar view, and its circular upward surface is used as a support surface 24. Note that, on the support surface 24 of the pad 26, vibration isolation rubber may be provided as required. The support surface 24 is a surface extending along the horizontal plane (X-Y plane). The mount unit 22 is not connected to the electric motor main unit 11, and does not restrict an up-down relative movement of the second end part 13B in the vertical direction (Z axis direction) that is vertical to the support surface 24.

As shown in FIG. 1A, the support structure A for the electric motor 10 has a support member (relative movement control member) 30. From the viewpoint of a restraining force as will be described later, the support member 30 is provided at a location farther away from the cantilever support unit 21 than the mount unit 22. The support member 30 restricts a relative movement between the electric motor main unit 11 and the mount unit 22 in the orthogonal direction (Y axis direction) that is parallel to the support surface 24 and is also orthogonal to the axial direction (X axis direction). Furthermore, the support member 30 enables relative movement between the electric motor main unit 11 and the mount unit 22 in the vertical direction (Z axis direction) that is vertical to the support surface 24.

As shown in FIG. 2, the support member 30 is connected to the second end part 13B of the electric motor main unit 11 and to the base 20. To be more specific, an upper side of the support member 30 is fixed to grounding sections (first fixation sections) 15, each of which forms a lower end of each leg unit 14 provided on the second end part 13B, with bolts 31. A lower side of the support member 30 is fixed to a fixation piece (second fixation section) 27, which is provided integrally with the base 20, with bolts 32. As shown in FIG. 1B, the support member 30 extends in the orthogonal direction (Y axis direction). The upper side of the support member 30 is fixed to the grounding sections 15 on both sides in the orthogonal direction, and the lower side of the support member 30 is fixed to the fixation piece 27 at a plurality of sites over the whole length in the orthogonal direction.

The support member 30 is a plate-like member machined from a single thin plate of metal such as steel or copper.

As shown in FIG. 2 with a broken line, the support member 30 has a spring characteristic of being freely deformable in the vertical direction (Z axis direction) that is vertical to the support surface 24. The support member 30 has a bent section 33 between the second end part 13B of the electric motor main unit 11 and the base 20. The bending angle of the bent section 33 of the present embodiment is a right angle.

The bent section 33 is provided so as to prevent the support member 30 from having rigidity in the vertical direction (Z axis direction). Other than the bent section 33, three bends (denoted with reference symbols 34, 35, and 36) are formed in the support member 30 of the present embodiment. As a result, the support member 30 is formed in a substantially Z shape. These bends (33, 34, 35, and 36) are formed in a short edge direction of the plate-like support member 30, and are not formed in a long edge direction thereof. In other words, the short edges of the plate-like support member 30 have the bends (33, 34, 35, and 36), and the support member 30 is deformable in the short edge direction. On the other hand, the long edges of the plate-like support member 30 have no bend, and the support member 30 extends linearly in the long edge direction. Therefore, the support member 30 is structured so that the rigidity in the orthogonal direction (Y axis direction) is high, but that the rigidity in the vertical direction (Z axis direction) is lower than that in the orthogonal direction to the extent of having hardly no rigidity in the vertical direction.

The support member 30 has an extension section 37 that linearly extends in the vertical direction (Z axis direction) between the second end part 13B of the electric motor main unit 11 and the base 20. As shown in FIG. 2, at least either one of the grounding section 15, which fixes the support member 30 to the second end part 13B of the electric motor main unit 11, and the fixation piece 27, which fixes the support member 30 to the base 20, does not have a support on the extended line of the extension section 37. The present embodiment is constructed so that the position of the fixation piece 27 provided on the lower side deviates from the extended line of the extension section 37 along the vertical direction, and hence, does not have a support on the side of the extension section 37 in the vertical direction. As a result, the extension section 37 is not vertically sandwiched between the grounding section 15 and the fixation piece 27, and thus is not vertically restricted by the grounding section 15 and the fixation piece 27.

Subsequently, operations of the support structure A for the electric motor 10 with the aforementioned construction will be described.

When operating the compressor 1 shown in FIG. 1A, the electric motor 10 is driven. The electric motor 10 revolves the bull gear 8 to revolve the rotor 5 to which the compressor impellers 2 are connected. With the revolution of the compressor impellers 2, the taken-in gas is compressed and pressurized. With the compression of the gas, the first-stage compressor 3 and the second-stage compressor 4 are heated to high temperatures.

The first-stage compressor 3 and the second-stage compressor 4 are supported on the base 20, and at least a part of the heat thereof is transmitted to the base 20. The base 20 is constructed so as to support the electric motor 10 in a cantilever manner, to thereby put the electric motor main unit 11, which is weak to heat, away from this heat source. Here, a difference in thermal expansion becomes large between the cantilever support unit 21, which supports the electric motor main unit 11 in a cantilever manner near the heat source, and the mount unit 22, which supports the electric motor main unit 11 away from the heat source.

If in this condition, the movement of the electric motor main unit 11 in the vertical direction on the free end side is restricted, then there is a possibility that an undue force is applied to the cantilever support unit 21. To address this, in the support structure A, the lower side of the second end part 13B of the electric motor main unit 11 is supported on the mount unit 22, thereby the mount unit 22 receives only the load of the electric motor main unit 11. This prevents an undue force from being applied to the cantilever support unit 21. However, because no support is provided in a direction parallel to the support surface 24, it is not possible to suppress vibration in the left-right direction (horizontal direction) only with the support by the mount unit 22. As a result, if the vibration based on the electric motor 10 becomes heavier in the case of an increased imbalance due to aged deterioration of the electric motor 10, or other cases, the vibration in the left-right direction (horizontal direction) is heavier.

As shown in FIG. 2, the support structure A of the present embodiment has the support member 30, and restricts the relative movement between the electric motor main unit 11 and the mount unit 22 in the orthogonal direction (Y axis direction) that is parallel to the support surface 24 and is also orthogonal to the axial direction. On the other hand, the support member 30 hardly restricts the relative movement between the electric motor main unit 11 and the mount unit 22 in the vertical direction (Z axis direction) that is vertical to the support surface 24.

Here, the orthogonal direction is a direction that is parallel to the support surface 24 of the mount unit 22 and is orthogonal to the axial direction of the electric motor main unit 11. Therefore, the orthogonal direction is a direction in which vibration caused by an imbalance of the electric motor 10 increases. The support member 30 restricts the relative movement in this orthogonal direction, to thereby effectively suppress vibration from shaft deflection caused by the imbalance of the electric motor 10.

Furthermore, the vertical direction is a direction that is vertical to the support surface 24 of the mount unit 22. Therefore, the vertical direction is a direction in which an existing, vertical relative movement between the electric motor main unit 11 and the mount unit 22 due to heat expansion is made. The support member 30 makes the relative movement in the vertical direction possible, to thereby maintain the existing relative movement, and prevent an undue force caused by difference in thermal expansion from applying to the electric motor 10.

Thus, according to the support structure A of the present embodiment, it is possible to achieve both of suppression of the vibration of the electric motor 10 and secure fixation of the electric motor 10.

The support member 30 of the present embodiment is a plate-like member that is connected to the second end part 13B of the electric motor main unit 11 and to the base 20, and that extends in the orthogonal direction. As shown in FIG. 1B, with the plate-like member being installed so as to extend in the orthogonal direction that is orthogonal to the axial direction, it is possible to establish, at a low cost, a structure that increases rigidity in the orthogonal direction and is not allowed to have rigidity in the vertical direction high enough to prohibit a thermal expansion of the electric motor main unit. Thus, with the relative movement between the electric motor main unit 11 and the mount unit 22 being controlled by the rigidity of the plate-like support member 30, it is possible to effectively suppress vibration of the electric motor 10 without incurring an increase in cost.

Furthermore, as shown in FIG. 2, the support member 30 has the bent section 33 between the second end part 13B of the electric motor main unit 11 and the base 20. With the bent section 33, which facilitates deformation of the support member 30, being provided partway between the second end part 13B of the electric motor main unit 11 and the base 20, it is possible to prevent the support member 30 from having rigidity in the vertical direction high enough to prohibit a thermal expansion of the electric motor main unit. On the other hand, with the bent section 33, rigidity of the support member 30 in the orthogonal direction is increased. Therefore, it is possible to more effectively suppress vibration from shaft deflection caused by an imbalance of the electric motor 10.

Furthermore, the support member 30 has the extension section 37 that extends in the vertical direction between the second end part 13B of the electric motor main unit 11 and the base 20. Besides, the fixation piece 27 that fixes the support member 30 to the base 20 does not have a support on the extended line of the extension section 37 along the vertical direction. Therefore, for example, the extension section 37 is not sandwiched between the grounding section 15 and the fixation piece 27 and is not restrained in the vertical direction, and hence, it is possible to prevent the support member 30 from having rigidity in the vertical direction high enough to prohibit a thermal expansion of the electric motor main unit. Therefore, in the vertical relative movement between the electric motor main unit 11 and the mount unit 22, the plate-like support member 30 is flexibly bent as shown in FIG. 2 with a broken line, to thereby prevent the support member 30 from having a restraining force.

Namely, the electric motor support structure A of the aforementioned present embodiment includes: a base 20 that has a cantilever support unit 21 and a mount unit 22, the cantilever support unit 21 supporting an electric motor main unit 11 with a first end part 13A thereof in an axial direction being fixed and a second end part 13B thereof being free, and the mount unit 22 having a support surface 24 that supports the second end part 13B of the electric motor main unit 11; and a support member 30 that restricts a relative movement between the electric motor main unit 11 and the mount unit 22 in an orthogonal direction parallel to the support surface 24 and also orthogonal to the axial direction, and that makes possible a relative movement between the electric motor main unit 11 and the mount unit 22 in a vertical direction vertical to the support surface 24. As a result, it is possible to suppress vibration without applying an undue force to the cantilever support unit 21.

While a preferred embodiment of the present invention has been described with reference to the drawings, the present invention is not limited to the aforementioned embodiment. Shapes, combinations, and the like of the constituent elements shown in the aforementioned embodiment are exemplary, and various modifications can be made based on the design requirements and the like without departing from the spirit or scope of the present invention.

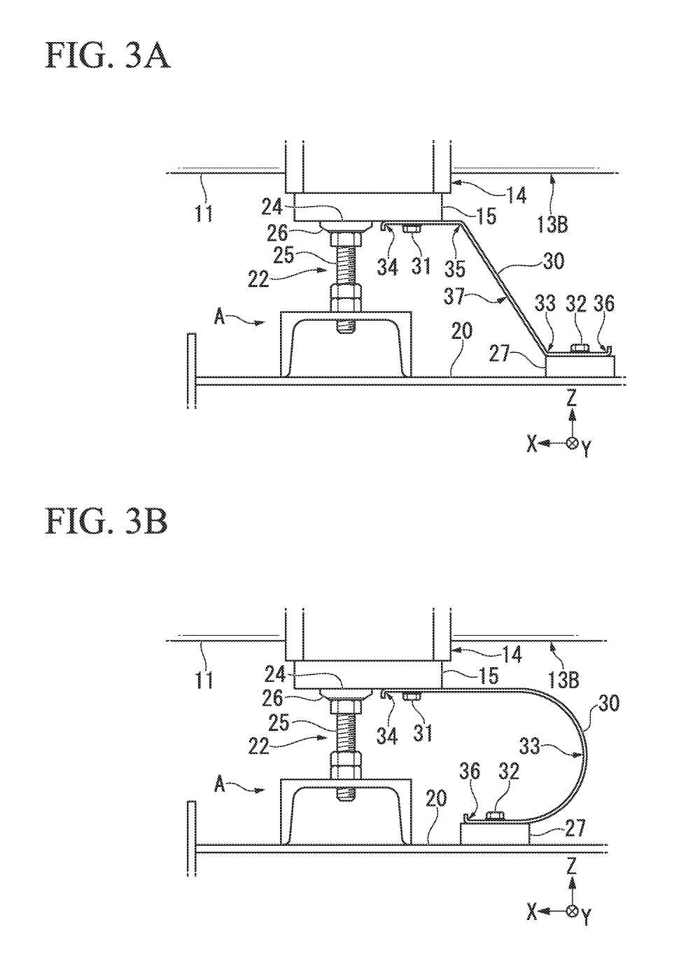

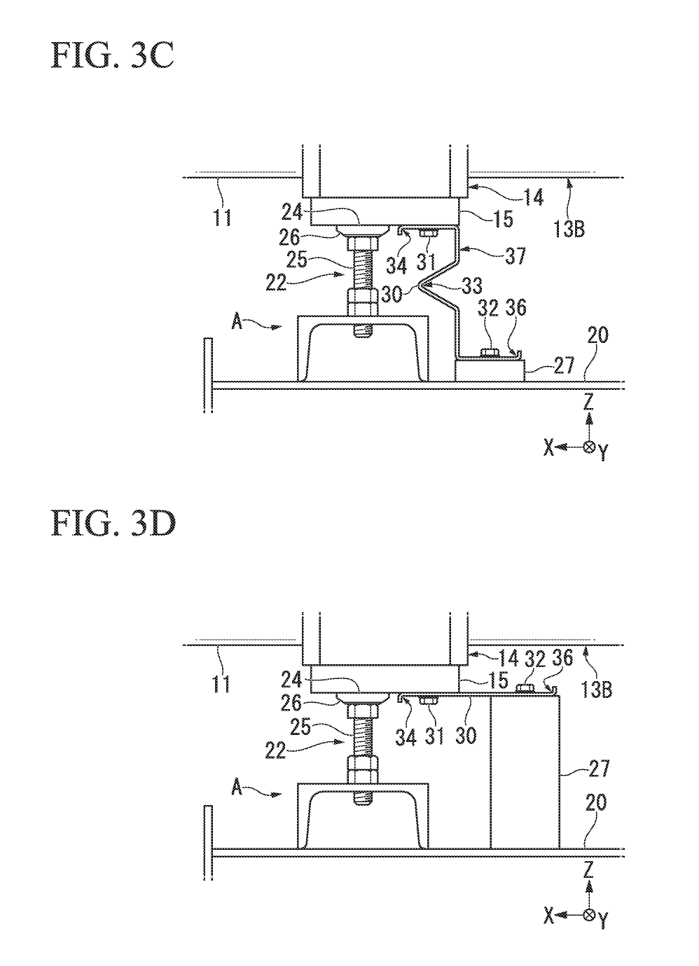

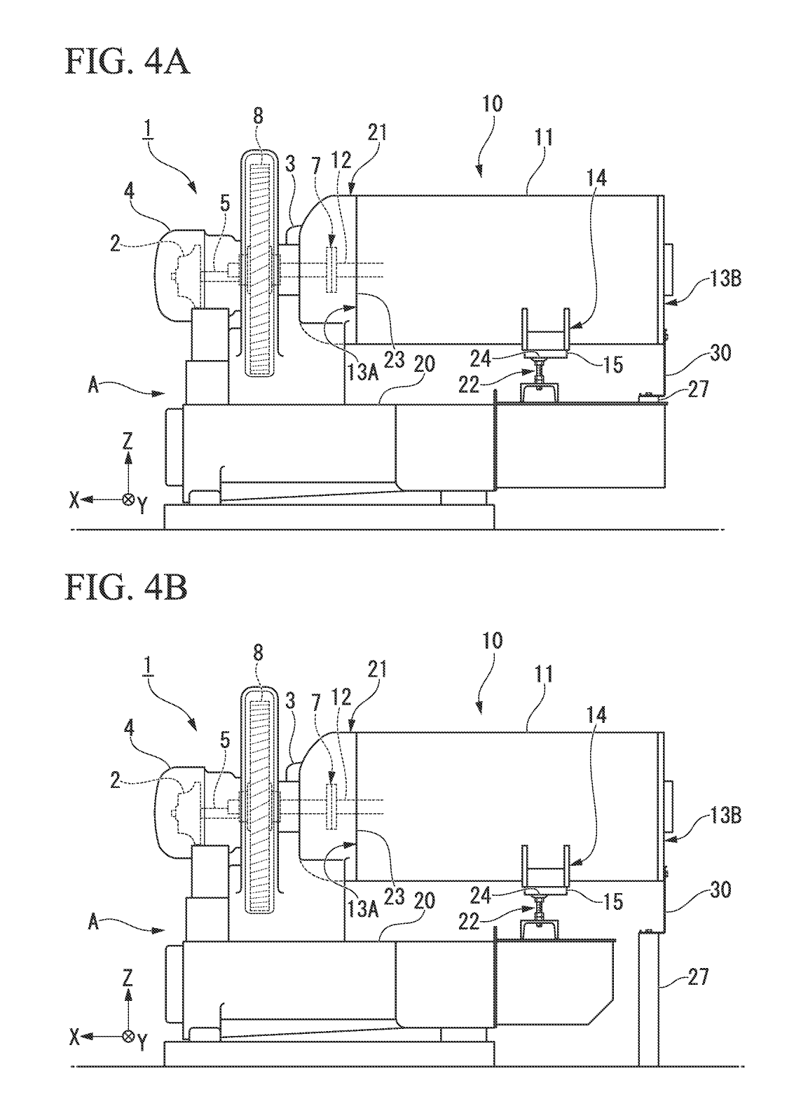

For example, it is possible for the present invention to achieve the operation and effect similar to those of the aforementioned embodiment in modifications such as shown in FIG. 3A to FIG. 3D, FIG. 4A, and FIG. 4B. In the following description, components the same as or similar to those of the aforementioned embodiment are denoted by the same reference symbols, and a description thereof is simplified or omitted.

In a support member 30 of another embodiment shown in FIG. 3A, a bending angle of a bent section 33 is an obtuse angle, and hence, an extension section 37 is slanted. Furthermore, a grounding section 15 does not have a support on an extended line of the extension section 37 along a slant direction.

A support member 30 of another embodiment shown in FIG. 3B has a curved bent section 33.

A support member 30 of another embodiment shown in FIG. 3C has a bent section 33 at partway of an extension section 37. Furthermore, a grounding section 15 and a fixation piece 27 have a support on an extended line of the extension section 37 along the vertical direction.

A support member 30 of another embodiment shown in FIG. 3D has a shape of a flat plate along the horizontal direction, which does not have a bend between a second end part 13B of an electric motor main unit 11 and a base 20.

Furthermore, in terms of suppressing vibration of the electric motor 10, the support member 30 is more effective as it is farther away from the flange section 23 to which the first end part 13A of the electric motor main unit 11 is connected. Therefore, the following constructions may be adopted.

In an electric motor support structure A of another embodiment shown in FIG. 4A, an upper section of a support member 30 is connected to an end surface of a second end part 13B of an electric motor main unit 11.

Furthermore, in an electric motor support structure A of another embodiment shown in FIG. 4B, an upper section of a support member 30 is connected to an end surface of a second end part 13B of an electric motor main unit 11. In addition, a lower section of the support member 30 is connected to a fixation piece 27 as an attachment base provided independently of a base 20. According to this construction, even in the case where the design does not allow the structure of the compressor 1 to be modified, addition of this construction makes measures against vibration effective with ease.

Furthermore, for example, in the aforementioned embodiment, illustration has been for the case where the electric motor support structure is applied to a turbo compressor. However, the present invention is not limited to this construction, but may be applied to, for example, a screw compressor, and besides, to a pump device or the like that is driven by an electric motor.

### INDUSTRIAL APPLICABILITY

According to the present invention, it is possible to obtain an electric motor support structure and a compressor that are capable of suppressing vibration without applying an undue force to a cantilever support unit.

### REFERENCE SIGNS LIST

A: electric motor support structure,
1: compressor,
10: electric motor,
11: electric motor main unit,
13A: first end part,
13B: second end part,
15: grounding section (first fixation section),
20: base,
21: cantilever support unit,
22: mount unit,
24: support surface,
27: fixation piece (second fixation section),
30: support member (relative movement control member, plate-like member),
33: bent section,
37: extension section

1. An electric motor support structure comprising:
a base that has a cantilever support unit and a mount unit, the cantilever support unit supporting an electric motor main unit with a first end part of the electric motor main unit in an axial direction being fixed and a second end part of the electric motor main unit being free, and the mount unit having a support surface that supports the second end part of the electric motor main unit; and
a relative movement control member that restricts a relative movement between the electric motor main unit and the mount unit in an orthogonal direction parallel to the support surface and orthogonal to the axial direction, and that makes possible relative movement between the electric motor main unit and the mount unit in a direction vertical to the support surface.

2. The electric motor support structure according to claim 1,
wherein the relative movement control member is a plate-like member that is connected to the second end part of the electric motor main unit and to the base, and that extends in the orthogonal direction.

3. The electric motor support structure according to claim 2,
wherein the plate-like member has a spring characteristic of being freely deformable in the vertical direction.

4. The electric motor support structure according to claim 2,
wherein the plate-like member has a bent section between the second end part of the electric motor main unit and the base.

5. The electric motor support structure according to claim 2, wherein:
the plate-like member has an extension section that extends linearly between the second end part of the electric motor main unit and the base; and
at least one of a first fixation section, which fixes the plate-like member to the second end part of the electric motor main unit, and a second fixation section, which fixes the plate-like member to the base, does not have a support on an extended line of the extension section.

6. A compressor comprising:
an electric motor; and
the electric motor support structure according to claim 1 as a support structure that supports the electric motor.
